(19) United States
(12) Patent Application Publication
(10) Pub. No.: US 2015/0120303 A1
(43) Pub. Date: Apr. 30, 2015

(54) SENTENCE SET GENERATING DEVICE, SENTENCE SET GENERATING METHOD, AND COMPUTER PROGRAM PRODUCT

(71) Applicant: KABUSHIKI KAISHA TOSHIBA, TOKYO (JP)

(72) Inventor: Yusuke Shinohara, Tokyo (JP)

(21) Appl. No.: 14/484,476

(22) Filed: Sep. 12, 2014

(30) Foreign Application Priority Data
Oct. 25, 2013 (JP) 2013-222597

(51) Int. Cl. G10L 13/02

(52) U.S. Cl. CPC G10L 13/02
USPC 704/258

(57) ABSTRACT

According to an embodiment, a sentence set generating device includes an importance degree storage, a frequency storage, a calculator, and a selector. The importance degree storage is configured to store therein a degree of importance of each of a plurality of acoustic units. The frequency storage is configured to store therein a frequency of appearance of each of the acoustic units in a second sentence set. The calculator is configured to calculate a score of a first sentence included in a first sentence set, from a degree of rarity corresponding to the frequency of appearance of each acoustic unit in the first sentence and from a degree of importance of the each acoustic unit. The selector is configured to, from sentences included in the first sentence set, select a sentence having a score higher than other sentences, and add the selected sentence to the second sentence set.

### CROSS-REFERENCE TO RELATED APPLICATION

This application is based upon and claims the benefit of priority from Japanese Patent Application No. 2013-222597, filed on Oct. 25, 2013; the entire contents of which are incorporated herein by reference.

### FIELD

Embodiments described herein relate generally to a sentence set generating device, a sentence set generating method, and a computer program product.

### BACKGROUND

During the development of a speech processing technology, there are many situations in which it becomes necessary to generate a set of sentences. For example, while developing a speech recognition system, there is a need to have a speech corpus. In order to record a speech corpus, the person responsible for reading aloud (i.e., the speaker) reads out the sentences included in a set of sentences which is generated in advance. In an identical manner, during speech synthesis too, in order to record a speech corpus that is to be used in the development, it is necessary to generate a set of sentences in advance. In another instance, in the case of performing speaker adaptation in a system for speech recognition or speech synthesis, there is a need for generating a set of sentences in advance for the speaker to read out.

Herein, for example, consider a case of generating a small set of sentences that includes about a few hundred sentences to thousand sentences. In that case, if the acoustic units having higher degrees of rarity are collected on a priority basis, then it becomes possible to generate the set of sentences with a smaller number of sentences.

However, for example, in order to generate a statistical model such as a Gaussian mixture model or a deep neural network, each acoustic unit needs to have a greater frequency of appearance. Besides, it becomes necessary to maintain a large set of sentences that includes, for example, a few thousand sentences to several tens of thousands of sentences or hundreds of thousands of sentences.

At the time of generating such a large set of sentences, if the technology of collecting on a priority basis the acoustic units having higher degrees of rarity is implemented; then, even after all acoustic units are covered, the acoustic units having higher degrees of rarity get collected on a priority basis. As a result, a set of sentences gets generated in which the acoustic units having low frequencies of usage in practice (i.e., the acoustic units that are inconsequential in practice) are included in large numbers. Besides, a sentence including a large number of acoustic units having low frequencies of usage is difficult to read, thereby leading to frequent mistakes in reading. That leads to an undesirable consequence of an increase in the recording cost.

### BRIEF DESCRIPTION OF THE DRAWINGS

FIG. 1 is a diagram for explaining the “merit” of a set of sentences;

FIG. 2 is a hardware configuration diagram of a sentence set generating device according to an embodiment;

FIG. 3 is a functional block diagram of the sentence set generating device according to the embodiment;

FIG. 4 is a flowchart for explaining a sentence set generating operation performed in the sentence set generating device according to the embodiment; and

FIG. 5 is a diagram for explaining a method that is given as a fourth method for setting the degrees of importance and that is implemented in an importance degree generator of the sentence set generating device according to the embodiment.

### DETAILED DESCRIPTION

According to an embodiment, a sentence set generating device includes a first-sentence-set storage, a second-sentence-set storage, an importance degree storage, a frequency storage, a score calculator, and a sentence selector. The first-sentence-set storage is configured to store therein a first sentence set. The second-sentence-set storage is configured to store therein a second sentence set. The importance degree storage is configured to store therein a degree of importance of each of a plurality of acoustic units. The frequency storage is configured to store therein a frequency of appearance of each of the acoustic units in the second sentence set. The score calculator is configured to calculate scores of first sentences that are each any one of sentences included in the first sentence set, from a degree of rarity corresponding to the frequency of appearance of each acoustic unit present in the corresponding first sentence and from the degree of degree of importance of the each acoustic unit in the corresponding first sentence. The sentence selector is configured to, from the first sentences included in the first sentence set, select on a priority basis one of the first sentences having a score higher than the other first sentences, and add the selected first sentence to the second sentence set stored in the second-sentence-set storage.

An exemplary embodiment of a sentence set generating device, a sentence set generating method, and a computer program product is described below in detail with reference to the accompanying drawings.

### PRINCIPLE OF EMBODIMENT

Given below are some of the methods for generating a set of sentences. One method is meant to generate a set of sentences that includes various acoustic units without any omission. In other words, in such a method, a set of sentences is generated in such a way that a high cover ratio of the acoustic units is achieved. Another method is meant to generate a set of sentences that includes a proper balance of various acoustic units. Still another method is meant to generate a set of sentences that has the distribution of the acoustic units close to the desired distribution. In all these methods, in order to generate a set of sentences, an optimum subset is extracted from a large set of sentences collected from, for example, newspapers, novels, web pages, and the like.

In the method meant to generate a set of sentences that includes a proper balance of various acoustic units, it is often the case that an objective function is maximized using an exchanging method. However, an exchanging method involves a large amount of calculation and is difficult to implement in generating a large set of sentences. Besides, many times, the method meant to generate a set of sentences that has the distribution of the acoustic units close to the desired distribution, a heuristic method is implemented. For that reason, there is a possibility that the algorithm is not most suitable.

In the method meant to generate a set of sentences that includes various acoustic units without any omission, the “greedy algorithm” is implemented in which sentences are rated based on the sum of the reciprocals of the frequencies of appearance of the acoustic units, and single sentences are selected one by one beginning with the sentence having the highest score. If the greedy algorithm is implemented, then it becomes possible to efficiently collect the acoustic units having low frequencies of appearance (i.e., the acoustic units having high degrees of rarity). For that reason, a set of sentences can be generated in which all acoustic units are covered in a smaller number of sentences.

In the same manner as the speech synthesis technique using voice piece selection, the greedy algorithm can be used at the time of generating a set of sentences in such a way that all acoustic units appear at least once or appear at least N number of times (for example, N=5). Moreover, the greedy algorithm is suitable for use in generating a small set of sentences that includes about a few hundred sentences to thousand sentences.

However, for example, in order to generate statistical model based on a Gaussian mixture model or a deep neural network, each acoustic unit needs to have a greater frequency of appearance. Besides, it becomes necessary to maintain a large set of sentences that includes, for example, a few thousand sentences to several tens of thousands of sentences or hundreds of thousands of sentences. Hence, if the greedy algorithm is implemented at the time of generating a large set of sentences; then, even after all acoustic units are covered, the acoustic units having higher degrees of rarity are collected on a priority basis. As a result, a set of sentences gets generated in which the acoustic units having low frequencies of usage in practice are included in large numbers. In other words, a set of sentences gets generated in which the acoustic units having low degrees of importance are included in large numbers. Besides, a sentence including a large number of acoustic units having low frequencies of usage is difficult to read, thereby leading to frequent mistakes in reading. That leads to an undesirable consequence of an increase in the recording cost.

In that regard, a sentence set generating device according to the embodiment takes into account the degrees of rarity of the acoustic units (i.e., the reciprocals of the frequencies of, appearance of the acoustic units) and the degrees of importance of the acoustic units, and is capable of efficiently generating a set of sentences that includes important and rare acoustic units in large numbers. Given below is the concrete explanation of the sentence set generating device according to the embodiment. Firstly, the term “acoustic unit” is defined. That is followed by the definition of the notation used in the explanation. That is followed by the definition of an objective function representing the “merit” of a set of sentences, and a sentence set generating problem is formulated as the problem of obtaining a set of sentences which maximizes the objective function. That is followed by the derivation of an algorithm which maximizes the objective function. Lastly, the explanation is given about the effect achieved by implementing the sentence set generating device according to the embodiment.

Definition of Acoustic Unit

As far as the acoustic units used in the sentence set generating device according to the embodiment are concerned; it is possible to use, for example, context-independent phonemes. Alternatively, it is possible to use context-dependent phonemes as the acoustic units. As the context-dependent phonemes, it is possible to use, for example, diphones representing chains of two phonemes or triphones representing chains of three phonemes.

Meanwhile, in the case of attempting an application to speech synthesis, in order to generate a set of sentences including diversified accents; if the same phonemes (such as a diphone) has a different accent (stress), then it is desirable to treat the accents as separate acoustic units. As another example, senones, that is, acoustic units in the context-clustered states of hidden Markov models can also be treated as the acoustic units.

Definition of Notation

In the explanation of the principle of the sentence set generating device according to the embodiment, the following notation is used.

a first sentence set: U={1, . . . , n}

the number of sentences included in the first sentence set: n

a second sentence set: S⊂U

a set of acoustic units of all types: P={1, . . . , m}

the number of types of acoustic units: m

the desired distribution of acoustic units: π=(π₁, . . . , πₘ)

the probability of appearance of the i-th acoustic unit:

$${π}_{i} ( i = 1 , … , m ; {\sum }_{i} {π}_{i} = 1 )$$

the frequency of appearance of the i-th acoustic unit in the second sentence set S: fᵢ(S) (i=1, . . . , m)

the total of the frequencies of appearance of the acoustic units in the second sentence set: f_{T}(S)

$${f}_{T} ( S ) = {\sum }_{i = 1}^{m} {f}_{i} ( S )$$

the probability of appearance of the i-th acoustic unit in the second sentence set: pᵢ(S) (i=1, . . . , m)

pᵢ(S)=fᵢ(S)/f_{T}(S)

the distribution of acoustic units in the second sentence set S: p=(p₁, . . . , pₘ)

Definition of Objective Function

The sentence set generating problem can be formulated as a problem of obtaining the second sentence set S that maximizes a set function J(S), which represents the “merit” of the second sentence set S, when there is an upper limit for the number of sentences. That is, consider a problem of obtaining the second sentence set S⊂U that maximizes the set function J(S) under the constraint of |S|≦B, where B represents the upper limit for the number of sentences. In the sentence set generating device according to the embodiment, the objective function J(S) representing the “merit” of the second sentence set S is defined using the equation given below.

$$J ( S ) = {\sum }_{i = 1}^{m} {π}_{i} log {f}_{i} ( S )$$

In the sentence set generating device according to the embodiment, regarding each acoustic unit (i=1, . . . , m), the objective function is designed to increase in a linear manner with respect to the logarithmic value of the frequency of appearance of that acoustic unit. Such exemplary designing is done because of the fact that, in many researches carried out regarding speech language information processing, the relationship between the logarithmic value of data volume and the performance (such as the speech recognition rate or the perplexity) can be subjected to linear approximation. Besides, a weighted sum is obtained depending on the probability of appearance πᵢ of the acoustic units. That is equivalent to obtaining an expected value according to the desired distribution π of the acoustic units.

Derivation of Algorithm

Next, an algorithm is derived for solving the problem of maximizing the abovementioned objective function J(S) under the constraint of |S|≦B.

The problem of maximizing the objective function J(S) is a combinatorial optimization problem, and it is difficult (NP-hard) to obtain an exact solution by implementing a polynomial time algorithm. Hence, consider a case of obtaining the second sentence set S that approximately maximizes the objective function J(S). In the following explanation, firstly, it is illustrated that the objective function J(S) has a property called submodularity. That is followed by the explanation about efficiently solving the abovementioned sentence set generating problem by implementing a method (the greedy algorithm) for efficiently maximizing a set function having submodularity.

Firstly, the explanation is given about the definition of submodularity. Assume that sets S, T, and U satisfy the relationship S⊂T⊂U. With respect to an arbitrary s E U\T, when a set function J satisfies the inequality given below, then it is said that the set function J has submodularity. Herein, U\T represents a difference set obtained by subtracting the set T from the set U.

J(S∪{s})−J(S)≧J(T∪{s})−J(T)

Next, it is illustrated that the abovementioned objective function J(S) has submodularity. In addition to the sentence sets U and S defined in the notation given above, a sentence set T that satisfies S⊂T is newly introduced. Consider the case of a sentence set {s} that includes only a single sentence s e U\T. Then, according to the definition of the objective function J(S), the following equation is satisfied.

$$\{ J ( S ⋃ \{ s \} ) - J ( S ) \} - \{ J ( T ⋃ \{ s \} ) - J ( T ) \} = {\sum }_{i = 1}^{m} {π}_{i} \times \{ log {f}_{i} ( S ⋃ \{ s \} ) - log {f}_{i} ( S ) - log {f}_{i} ( T ⋃ \{ s \} ) + log {f}_{i} ( T ) \}$$

Herein, with respect to real numbers x, y, and d that satisfy 0<x≦y and 0≦d; it is assumed that a logarithmic function satisfies the inequality given below. Thus, that fact is put to use.

log(x+d−log(x)≧log(y+d)−log(y)

Thus, for each i, if x=fᵢ(S), y=fᵢ(T), d=fᵢ(S∪{s})−fᵢ(S)=fᵢ(T∪{s})−fᵢ(T)=fᵢ({s}) is set; then the following expression is formulated in order to satisfy the abovementioned relational expressions 0<x≦y and 0≦d.

log fᵢ(S∪{s})−log fᵢ(S)≧log fᵢ(T∪{s})−log fᵢ(T)

With that, it becomes possible to obtain the result of the expression given below, and it is found that the set function J(S) has submodularity.

{J(S∪{s})−J(S)}−{J(T∪{s})−J(T)}≧0

The problem of maximizing the set function J(S) having submodularity under the constraint of |S|≦B that is related to the size of the set S can be obtained, that is, S*⊂U in

$${S}^{*} = {argmax}_{\vert S \vert \leq B} J ( S )$$

can De obtained in an efficient manner by implementing the greedy algorithm. According to Kiyohito NAGANO, “Submodular optimization as basic technologies”, the Communications of the Operations Research Society of Japan, January 2011, pp. 27-32, it has been demonstrated that the greedy algorithm is theoretically near-optimal. Thus, it is a difficult task to develop a polynomial time algorithm that is capable of achieving the performance exceeding the greedy algorithm.

In the greedy algorithm, starting from the state in which S is an empty set, that is, starting from the state of S=Φ; in each iteration, such sεU\S is selected which maximizes J(S∪{s}), and then S←S∪{s} is set. A pseudo-code for that is as follows.

```
Input: U, B
S ← Φ
While |S| < B
  ${s}^{*} ← {arg max}_{s ∈ U / S} J ( S ⋃ \{ s \} )$
  S ← S ∪ s*
Output: S
```

Herein, the explanation is given about a method for executing the pseudo-code in a more efficient manner. When a sentence sεU\S is added to the sentence set S, if the increment is set in the manner given below in Equation (1), then Equation (2) given below is obtained.

$$\begin{matrix}{{δ}_{s} ( S )}^{def} = J ( S ⋃ \{ s \} ) - J ( S ) & ( 1 ) \\ {δ}_{s} ( S ) = {\sum }_{i = 1}^{m} {π}_{i} ( log {f}_{i} ( S ⋃ \{ s \} ) - log {f}_{i} ( S ) ) & ( 2 )\end{matrix}$$

In the case of Δx<<x, an approximation expressed below in Equation (3) is established.

$$log ( x + Δ x ) - log ( x ) \approx Δ x {log}^{′} ( x ) = \frac{Δ x}{x} \qquad ( 3 )$$

Under the assumption that the increment in the frequency of appearance of each acoustic unit is sufficiently smaller in comparison with the original frequency of appearance of that acoustic unit; δₛ(S) can be calculated using an approximation expression given below in Equation (4).

$${δ}_{s} ( S ) \approx {\sum }_{i = 1}^{m} {π}_{i} \frac{{f}_{i} ( S ⋃ \{ s \} ) - {f}_{i} ( S )}{{f}_{i} ( S )} = {\sum }_{i = 1}^{m} {π}_{i} \frac{{f}_{i} ( \{ s \} )}{{f}_{i} ( S )} \qquad ( 4 )$$

Thus, at the time of adding a sentence s, the increment δₛ(S) of the objective function can be calculated as follows: regarding each acoustic unit constituting the sentence s, a product of the degree of importance (πᵢ) of that acoustic unit and the reciprocal (1/fᵢ(S)) of the frequency of appearance of that acoustic unit is calculated, and then the increment δₛ(S) is calculated using the sum of all products. During each iteration of the pseudo-code given above, such “s” is selected for which the objective function has the highest increment. Thus, using the equation given below, the greedy algorithm can be executed in a more efficient manner.

$${s}^{*} ← {argmax}_{s ∈ U \backslash S} {δ}_{s} ( S )$$

### Example of Effect of Embodiment

Given below is the explanation about a case in which, when the desired distribution of acoustic units and the upper limit of the cost (i.e., the upper limit of the number of sentences) is provided, the use of the abovementioned objective function and the abovementioned algorithm enables generating a set of sentences having the smallest “distance” from the desired distribution of acoustic units. Herein, it is assumed that the “distance” between distributions is measured using the Kullback-Leibler divergence (hereinafter, referred to as KL divergence).

Thus, it is demonstrated that maximizing the abovementioned objective function J(S) under the constraint of |S|≦B is equivalent to minimizing a KL divergence D(π∥p) between a given distribution π of acoustic units and a distribution p(S) of the acoustic units of S.

In the following explanation, firstly, it is demonstrated that “the merit of a set of sentences is equal to subtracting the ‘bias’ of the set of sentences from the ‘size’ of the sentence set”. Then, it is explained that the abovementioned subtraction is equivalent to the algorithm for minimizing the KL divergence.

Firstly, the explanation is given about the “bias” of a set of sentences. Herein, the “bias” represents the gap between the given distribution it of acoustic units and the distribution p(S) of the acoustic units of S. More particularly, as given below in Equation (5), the KL divergence between π and p(S) represents the bias of the data.

$$\begin{matrix}{{D}_{KL} ( π \vert \vert p ( S ) )}^{def} = {\sum }_{i = 1}^{m} {π}_{i} log \frac{{π}_{i}}{{p}_{i} ( S )} \\ = - {\sum }_{i = 1}^{m} {π}_{i} log {p}_{i} ( S ) + Const\end{matrix} \qquad ( 5 )$$

Herein, if the definitional identity of pᵢ(S) is substituted, then Equation (6) given below is obtained.

$$\begin{matrix}{D}_{KL} ( π \vert \vert p ( S ) ) = - {\sum }_{i} {π}_{i} log \frac{{f}_{i} ( S )}{{f}_{T} ( S )} + Const \\ = - {\sum }_{i} {π}_{i} log {f}_{i} ( S ) + log {f}_{T} ( S ) + Const\end{matrix} \qquad ( 6 )$$

Moreover, if Equation (6) is subjected to readjustment on both sides, then Equation (7) given below is obtained.

J(S)=log f_{T}(S)−D_{KL}(π∥p(S))+Const (7)

In Equation (7), each term has a meaning as follows.

J(S): the “merit” of the sentence set S

log f_{T}(S): the “size” of the sentence set S

D_{KL}(π∥p(S): the “bias” of the sentence set S

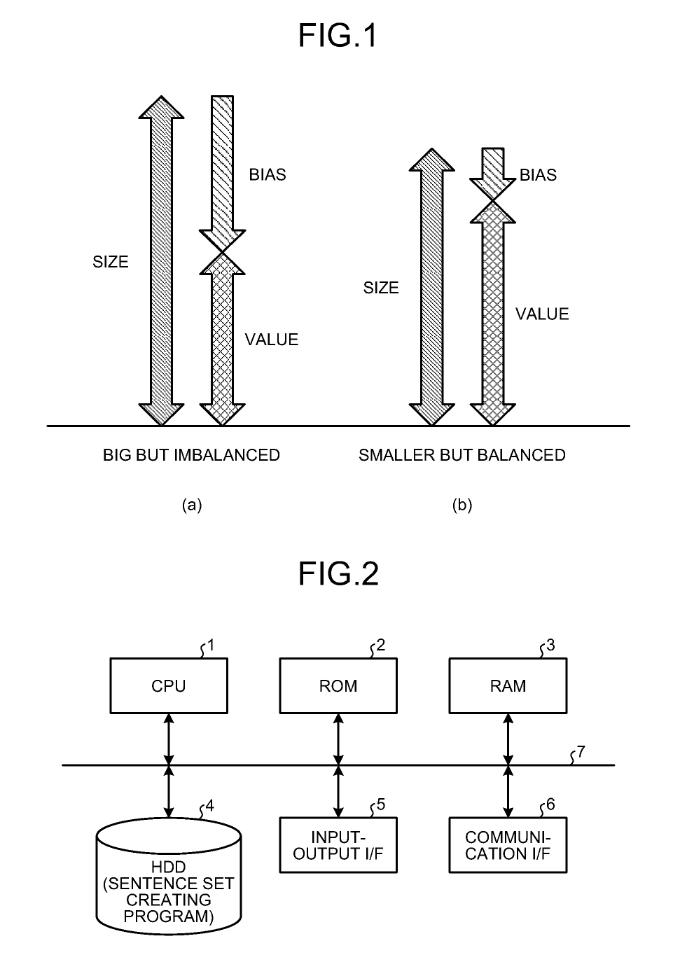

Thus, it can be said that the “merit” of a set of sentences is equal to subtracting the “bias” of that set of sentences from the “size” of that sentence set. That is, larger the set of sentences or smaller the “bias” of the set of sentences, greater is the value of the sentence set. For example, as illustrated in (a) in FIG. 1, although a set of sentences may be big in size, the value thereof is low if the “bias” is large. In contrast, as illustrated in (b) in FIG. 1, although a set of sentences may be small is small, the value thereof becomes high if the bias is small. That is the meaning of the “merit” of a sentence set.

The algorithm described above is implemented to obtain such a sentence set S, from among the sentence sets S satisfying |S|≦B, for which the objective function J(S) takes the maximum value. When |S|=B is satisfied, the objective function J(S) takes the maximum value. Hence, if it is assumed that the length of each sentence (the length of an array of acoustic units) included in the first sentence set U is constant and if L represents the length of the array of acoustic units, then the condition for |S|=B to satisfy is rewritten with a condition for log f_{T}(S)=B′ to satisfy. Herein, B′=log(BL) is satisfied.

Thus, it can be said that the algorithm described above is a method for maximizing the “merit” of a set of sentences at the given “size” of the sentence set. In other words, it can be said that the algorithm described above is a method for minimizing the “bias” of the sentence set. Therefore, using the sentence set generating device according to the embodiment, it becomes possible to generate a set of sentences that minimizes the KL divergence between the given distribution π of acoustic units and the distribution p(S) of the acoustic units of the set of sentences.

Meanwhile, the explanation herein is given under the assumption that “each sentence included in the first sentence set U has the same length”. This assumption is valid to a large number of applications. For example, in the case of generating a set of sentences that is to be read during the recording of a speech corpus, it is often the case that the set of sentences U is generated from only those sentences which have the lengths within a certain range (i.e., only those sentences which have the substantially same length). Alternatively, even in the case in which the sentences in the set of sentences U have different lengths, a set of sentences can be generated which minimizes the KL divergence on the basis of a substantially identical argument as the argument stated above.

### Realization of Embodiment

Although given only as an example, the sentence set generating device according to the embodiment can be implemented using a hardware configuration equivalent to the hardware configuration of a commonplace personal computer device. FIG. 2 is a hardware configuration diagram of the sentence set generating device. As illustrated in FIG. 2, the sentence set generating device includes a central processing unit (CPU) 1, a read only memory (ROM) 2, a random access memory (RAM) 3, a hard disk drive (HDD) 4, an input-output interface (I/F) 5, and a communication I/F 6. Herein, the CPU 1, the ROM 2, the RAM 3, the HDD 4, the input-output I/F 5, and the communication I/F 6 are connected to each other in a communicable manner by a bus line 7.

The CPU 1 follows instructions written in a sentence set generating program that is stored in advance in the ROM 2, or in the RAM 3, or in the HDD 4; performs operations using the RAM 3 as a work memory; and controls the operations of the sentence set generating device in entirety. In the example illustrated in FIG. 2, the sentence set generating program is stored in the HDD 4. Alternatively, the sentence set generating program can be downloaded from a computer device, which is installed on a predetermined network, via the network. Still alternatively, the sentence set generating program can be recorded in the form of an installable or an executable file in a computer-readable recording medium such as a compact disk (CD) or a digital versatile disk (DVD).

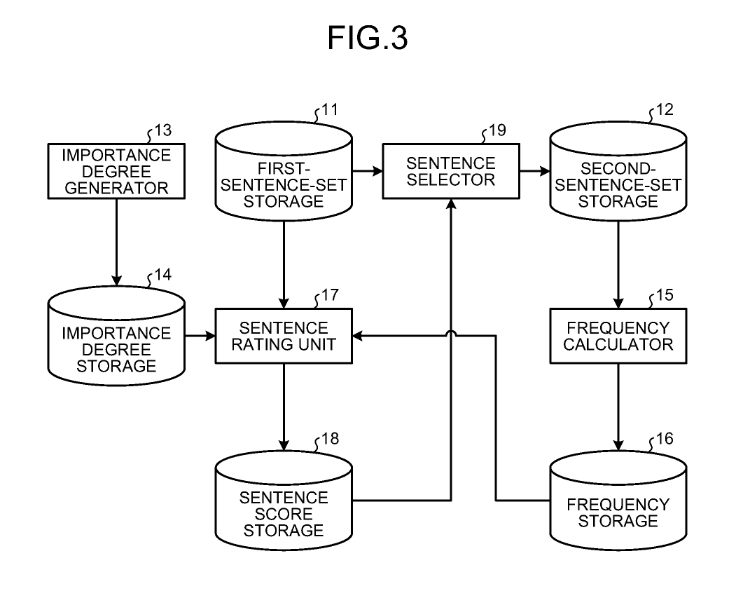

FIG. 3 is a functional block diagram of the sentence set generating device. The functions illustrated in FIG. 3 can either be implemented as software using only the sentence set generating program; or can be implemented using a combination of software and hardware; or can be implemented using only hardware. As illustrated in FIG. 3, the sentence set generating device includes a first-sentence-set storage 11 that is used to store the first sentence set; and includes a second-sentence-set storage 12 that is used to store the second sentence set.

Moreover, the sentence set Storing device also includes an importance degree generator 13 that generates importance degree information indicating the degree of importance of each acoustic unit; includes an importance degree storage 14 that is used to store the importance degree information of each acoustic unit; and includes a frequency calculator 15 that calculates the frequency of appearance of each acoustic unit present in the second sentence set. Furthermore, the sentence set generating device also includes a frequency storage 16 that is used to store the calculated frequency of appearance of each acoustic unit; and includes a sentence rating unit 17 that assigns scores to the sentences included in the first sentence set. Moreover, the sentence set generating device also includes a sentence score storage 18 that is used to store the given scores; and a sentence selector 19 that selects the sentence having the highest score from the first sentence set and adds the selected sentence to the second sentence set. The sentence rating unit 17 is an example of a score calculator.

In the first-sentence-set storage 11 is stored the first sentence set which represents the original data set. In the sentence set generating device, a set of sentences is generated by selecting one or more sentences from the first sentence set and adding the selected sentences to the second sentence set. That is, a subset is extracted from the first sentence set and is added to the second sentence set. As the first sentence set, it is possible to use a set of sentences collected from, for example, newspapers, novels, web pages, and the like.

The second-sentence-set storage 12 is used to store the second sentence set. Typically, the second sentence set is initialized to an empty set. As another example, the set of sentences included in the currently-possessed speech corpus can be used as the initial value of the second sentence set. Once the second sentence set is initialized in some way (for example, initialized to an empty set), one or more sentences that are selected from the first sentence set are added to the second sentence set, and the resultant set of sentences serves as the output of the sentence set generating device.

In the embodiment, a “sentence” points to a string of characters, such as “It is fine today.”, which can be converted into an array of acoustic units using a pronunciation dictionary in which the pronunciation (the array of acoustic units) of each word is defined. Thus, the exemplary string of characters “It is fine today.” can be converted into “itisfine . . . ” as the array of acoustic units.

Meanwhile, it is also possible to use context-dependent phonemes as the acoustic units. Of the context-dependent phonemes; in the case of using triphones, the exemplary string of characters “It is fine today.” is converted into “i+t i−t+i t−i+s i−s+f s−f+i f−i+n i−n+e . . . ” as the array of acoustic units.

Keeping in mind the explanation given below, it is assumed that “m” represents the number of types of acoustic units. In Japanese language, in the case of using context-independent phonemes as the acoustic units, the value of “m” is about 50. In the case of using triphones as the acoustic units, the value of “m” is about 5000.

The frequency calculator 15 calculates the frequency of appearance of each acoustic unit included in the second sentence set. The frequency storage 16 is used to store information indicating the frequency of appearance of each acoustic unit. Thus, regarding each of the m number of acoustic units, the frequency calculator 15 counts the number of times for which that acoustic unit appears in the second sentence set. The frequency storage 16 is used to store information that indicates the frequency of appearance of each of the m number of acoustic units in the second sentence set.

The importance degree storage 14 is used to store information that indicates the degree of importance generated by the importance degree generator 13 for each of the m number of acoustic units. Herein, the importance degree generator 13 sets the degree of importance for an acoustic unit by implementing, for example, any one of a first method to a fourth method described below.

In the first method, the importance degree generator 13 sets an identical degree of importance (for example, 1.0) for all acoustic units. Using such a degree of importance for acoustic units is equivalent to setting the “desired distribution π of desired acoustic units”, which is explained above in the principle section, to a uniform distribution. Moreover, the first method is identical to the method disclosed in J.-S. Zhang and S. Nakamura, “An Improved Greedy Search Algorithm for the Development of a Phonetically Rich Speech Corpus”, IEICE Trans. INF. & SYST., Vol. E91-D, No. 3, March 2008, pp. 615-630. However, as a result of implementing the first method, there is a possibility that a set of sentences is generated which includes rare but inconsequential acoustic units (in a typical sentence, the acoustic units having low frequencies of usage) in large numbers.

In the second method, the importance degree generator 13 calculates the frequency of appearance of each acoustic unit that is included in a set of sentences collected without bias from various categories such as newspapers, novels, web pages, and the like. Herein, the importance degree generator 13 sets the calculated frequency of appearance of each acoustic unit as the degree of importance of that acoustic unit. However, if the frequencies of appearance of the acoustic units are set to be the degrees of importance, then there is a possibility that a set of sentences is generated in which the acoustic units having high frequencies of appearance are present in large numbers. That leads to a situation in which some acoustic units have extremely low frequencies of appearance.

In the third method, the importance degree generator 13 calculates the frequency of appearance of each acoustic unit from an appropriate set of sentences. Then, the importance degree generator 13 performs setting in such a way that, the higher the frequency of appearance of an acoustic unit, the greater the degree of importance of that acoustic unit (i.e., sets the degrees of importance according to the frequencies of appearance). In this case, firstly, in an identical manner to the second method described above, the frequency of appearance of each acoustic unit is obtained from a set of sentences that is collected from various categories. Then, a value is obtained by converting the frequency of appearance of an acoustic unit using a monotonically increasing function “g”, and the obtained value is set as the degree of importance of that acoustic unit. For example, as the monotonically increasing function “g”, it is possible to use a concave monotonically increasing function (such as a logarithmic function). With that, in a typical sentence, the higher the frequency of usage of an acoustic unit, the greater the degree of importance assigned to that acoustic unit. Thus, as compared to the second embodiment, the acoustic units having high degrees of rarity are also included in a moderate manner. As a result, it becomes possible to generate a well-balanced set of sentences.

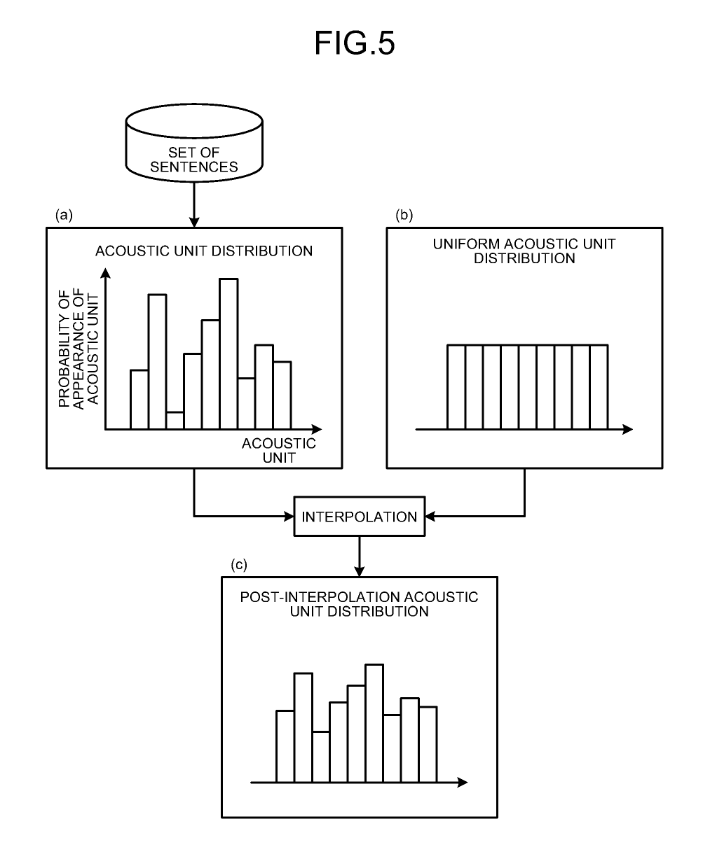

In the fourth method, firstly, in an identical manner to the second method described above, the importance degree generator 13 calculates the frequency of appearance of each acoustic unit from an appropriate set of sentences that includes typical sentences; and obtains an acoustic unit distribution as illustrated in (a) in FIG. 5. Then, with respect to the acoustic unit distribution obtained from the set of sentences, the importance degree generator 13 performs an interpolation operation with a uniform acoustic unit distribution illustrated in (b) in FIG. 5. As a result of the interpolation operation, for example, it becomes possible to obtain an interpolated acoustic unit distribution illustrated in (c) in FIG. 5. Then, the importance degree generator 13 treats the probability of appearance of each acoustic unit in the interpolated acoustic unit distribution as the degree of importance of that acoustic unit.

In this fourth method, if interpolation with a uniform acoustic unit distribution is not performed; then, in an identical manner to the second method, only the important acoustic units (i.e., only the acoustic units having high frequencies of appearance) are collected. On the other hand, if only a uniform acoustic unit distribution is used; then, in an identical manner to the first method, only the acoustic units having high degrees of rarity are collected. In that regard, in the fourth embodiment, the acoustic unit distribution of the frequencies of appearance of the acoustic units obtained from a set of sentences including typical sentences is interpolated with a uniform acoustic unit distribution. For that reason, it becomes possible to generate a set of sentences that includes a large number of acoustic units having high degrees of importance as well as high degrees of rarity.

Subsequently, the sentence rating unit 17 assigns scores to the sentences included in the first sentence set. More particularly, the sentence rating unit 17 refers to the frequencies of appearance of the acoustic units as stored in the frequency storage 16 and refers to the degrees of importance of the acoustic units as stored in the importance degree storage 14, and calculates a score for a single sentence that is arbitrarily provided from the first sentence set.

More particularly, firstly, the sentence rating unit 17 calculates the product of the degree of importance and the degree of rarity of each acoustic unit included in the array of acoustic units present in the sentence that is arbitrarily provided from the first sentence set. Herein, although given only as an example, the reciprocals of the frequencies of appearance of the acoustic units can be treated as the degrees of rarity. Then, the sentence rating unit 17 sets the sum of the products as the score of the single sentence that is arbitrarily provided from the first sentence set. The sentence score storage 18 is used to store the score calculated by the sentence rating unit 17.

The arithmetic expression for a score is as given below. Herein, “K” represents the length of the array of acoustic units in a single sentence that is arbitrarily provided from the first sentence set. Moreover, “i(k)” (k=1, . . . , K; iε{1, . . . , m}) represents an identification number (ID: identifier) of the k-th acoustic unit. Furthermore, for the acoustic unit having the identification number i; πᵢ represents the degree of importance and fᵢ represents the frequency of appearance. In that case, for the single sentence that is arbitrarily provided from the first sentence set, the score is calculated using the following equation.

$$Score = {\sum }_{k = 1}^{K} {π}_{i ( k )} \times ( 1 / {f}_{i ( k )} )$$

The sentence score storage 18 is used to store information indicating the score calculated by the sentence rating unit 17 for each sentence included in the first sentence set.

The sentence selector 19 refers to the sentence score storage 18; selects on a priority basis the sentence having a higher score than the other sentences; and adds that sentence to the second sentence set stored in the second-sentence-set storage 12. As an example, the sentence selector 19 selects the sentences having the scores equal to or greater than a threshold value. Alternatively, the sentence selector 19 selects the sentence having the highest score.

### Operations in Embodiment

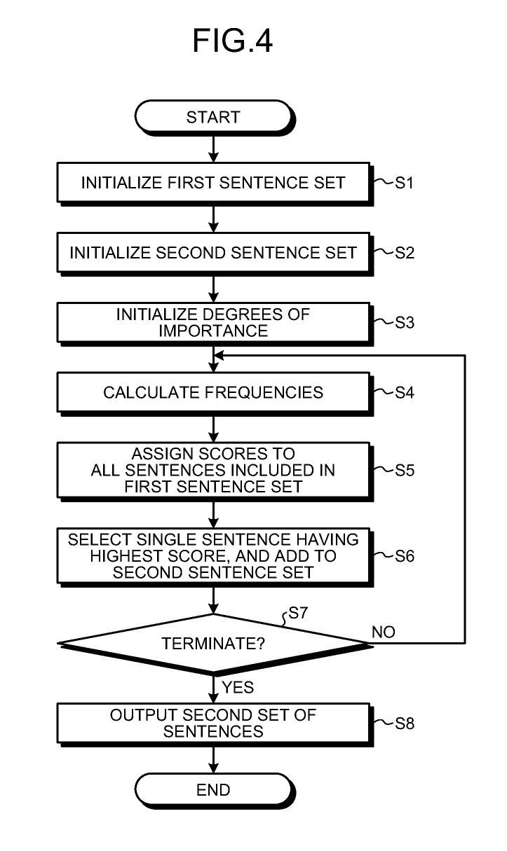

FIG. 4 is a flowchart for explaining the operations performed in the sentence set generating device according to the embodiment. With reference to the flowchart illustrated in FIG. 4, the first sentence set is initialized (Step S1). Herein, for example, a set of sentences collected from, for example, newspapers, novels, web pages, and the like can be used as the first sentence set.

Then, the second sentence set is initialized (Step S2). Herein, for example, an empty set can be used as the initial value of the second sentence set.

Subsequently, the degrees of importance of the acoustic units are initialized (Step S3). Herein, for example, all acoustic units are set to have an identical value (for example, 1.0).

Then, the frequency calculator 15 calculates the frequency of appearance of each acoustic unit included in the second sentence set, and the frequency storage 16 is used to store information indicating the frequency of appearance of each acoustic unit (Step S4).

Subsequently, the sentence rating unit 17 assigns a score to each sentence included in the first sentence set, and stores the information indicating scores of the sentences in the sentence score storage 18 (Step S5).

Then, the sentence selector 19 refers to the sentence score storage 18; selects the sentence having the highest score from the first sentence set; and adds that sentence to the second sentence set (Step S6). Moreover, the sentence selector 19 deletes the selected sentence from the first-sentence-set storage 11.

Subsequently, it is determined whether or not a termination condition is satisfied (Step S7). If the termination condition is satisfied (Yes at Step S7), then the system control proceeds to Step S8. However, if the termination condition is not satisfied (No at Step S7), then the system control returns to Step S4. For example, selection of a predetermined number of sentences can be set as the termination condition. Alternatively, a condition in which the sum of the frequencies of appearance of the acoustic units included in the second sentence set exceeds a predetermined value can be set as the termination condition.

Lastly, the set of sentences stored in the second-sentence-set storage 12 is output to the outside (Step S8).

As is clear from the explanation given above, by taking into account the degrees of rarity as well as the degrees of importance of the acoustic units, the sentence set generating device according to the embodiment can efficiently generate a set of sentences in which important as well as rare acoustic units are included in large numbers.

### Modification of Embodiment

In the sentence set generating device according to the embodiment, it is assumed that the “greedy algorithm” is implemented. However, instead of the greedy algorithm, it is also possible to implement the “high-speed greedy algorithm” described in Jure Leskovec, Andreas Krause, Carlos Guestrin, Christos Faloutsos, Jeanne VanBriesen, Natalie Glance, “Cost-effective Outbreak Detection in Networks”, in Proceedings of the 13th ACM SIGKDD International Conference on Knowledge Discovery and Data Mining, pages 420-429, 2007 (hereinafter, Leskovec).

As is clear from the description of Leskovec, as a result of implementing the high-speed greedy algorithm, the location for installing a sensor can be selected at a high speed that is faster by about 700 times than the simple greedy algorithm. For that reason, in the sentence set generating device according to the embodiment, if the high-speed greedy algorithm is implemented instead of the greedy algorithm, it becomes possible to substantially cut down the time taken for generating a set of sentences (i.e., it becomes possible to generate a set of sentences at a very high speed).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sentence set generating device comprising:
a first-sentence-set storage configured to store therein a first sentence set;
a second-sentence-set storage configured to store therein a second sentence set;
an importance degree storage configured to store therein a degree of importance of each of a plurality of acoustic units;
a frequency storage configured to store therein a frequency of appearance of each of the acoustic units in the second sentence set;
a score calculator configured to calculate scores of first sentences that are each of sentences included in the first sentence set, from a degree of rarity corresponding to the frequency of appearance of each acoustic unit in the corresponding first sentence and from the degree of importance of the each acoustic unit in the corresponding first sentence; and
a sentence selector configured to, from the first sentences included in the first sentence set, select on a priority basis one of the first sentences having a score higher than the other first sentences, and add the selected first sentence to the second sentence set stored in the second-sentence-set storage.

2. The device according to claim 1, wherein the lower the frequency of appearance of the acoustic unit, the greater the degree of rarity.

3. The device according to claim 1, wherein the degree of rarity is a reciprocal of the frequency of appearance of the acoustic unit.

4. The device according to claim 1, wherein the higher the frequency of appearance of the acoustic unit, the greater the degree of importance.

5. The device according to claim 1, wherein the importance degree storage is configured to store therein, as the degrees of importance of the acoustic units, probabilities of appearance of acoustic units in an interpolated acoustic unit distribution obtained by interpolating an acoustic unit distribution corresponding to frequencies of appearance of acoustic units in a set of sentences with a uniform acoustic unit distribution.

6. The device according to claim 1, wherein the acoustic units are context-independent phonemes, or context-dependent phonemes, or acoustic units in context-clustered states of hidden Markov models.

7. A sentence set generating method comprising:
calculating scores of first sentences that are each of sentences included in a first sentence set, from a degree of rarity of each acoustic unit in the corresponding first sentence and from a degree of importance of the each acoustic unit in the corresponding first sentence, the degree of rarity being obtained by referring to a frequency of appearance of the corresponding acoustic unit in a second sentence, the frequency of appearance being stored in a frequency storage;
selecting, from the first sentences included in the first sentence set, on a priority basis one of the first sentences having a score higher than the other first sentences; and
adding the selected first sentence to the second sentence set.

8. A computer program product comprising a computer-readable medium containing a program executed by a computer, the program causing the computer to execute:
calculating scores of first sentences that are each of sentences included in a first sentence set, from a degree of rarity of each acoustic unit in the corresponding first sentence and from a degree of importance of the each acoustic unit in the corresponding first sentence, the degree of rarity being obtained by referring to a frequency of appearance of the corresponding acoustic unit in a second sentence, the frequency of appearance being stored in a frequency storage;
selecting, from the first sentences included in the first sentence set, on a priority basis one of the first sentences having a score higher than the other first sentences; and
adding the selected first sentence to the second sentence set.
